(19) United States
(12) Patent Application Publication
(10) Pub. No.: US 2025/0027786 A1
(43) Pub. Date: Jan. 23, 2025

(54) METHOD AND DEVICE FOR CREATING A DIGITAL MAP

(71) Applicant: Robert Bosch GmbH, Stuttgart (DE)

(72) Inventor: Jan Rohde, Stuttgart (DE)

(21) Appl. No.: 18/767,229

(22) Filed: Jul. 9, 2024

(30) Foreign Application Priority Data
Jul. 21, 2023 (DE) 10 2023 206 933.4

(51) Int. Cl. G01C 21/00; B60W 60/00

(52) U.S. Cl. CPC G01C 21/3815; B60W 60/0027; B60W 2554/4041

(57) ABSTRACT

A method and a device for creating a digital map. Map data values representing a base map are retrieved, wherein the base map includes information on traffic routes with one or more lanes and surroundings features, wherein this information represents at least one configuration of the lanes, wherein the surroundings features represent geographical objects, which can be detected by means of a surroundings sensor system of a vehicle. Areas that make automated driving possible depending on the configuration of the lanes and depending on the surroundings features are determined. A method for operating an automated vehicle is also described, in which a driving strategy is determined depending on the current position on the basis of a digital map, wherein the driving strategy includes a trajectory to an area that makes automated driving possible, wherein the automated vehicle is operated depending on the driving strategy.

### CROSS REFERENCE

The present application claims the benefit under 35 U.S.C. § 119 of German Patent Application No. DE 10 2023 206 933.4 filed on Jul. 21, 2023, which is expressly incorporated herein by reference in its entirety.

### FIELD

The present invention inter alia relates to a method for creating a digital map, wherein the digital map is created by supplementing a base map with the areas that make automated driving possible, and to a method for operating an automated vehicle, depending on the driving strategy, wherein the driving strategy for the automated vehicle was created depending on a current position on the basis of a digital map.

### SUMMARY

According to an example embodiment of the present invention, a method for creating a digital map comprises a step of retrieving map data values representing a base map, wherein the base map comprises information on traffic routes with one or more lanes and surroundings features, wherein said information represents at least one configuration of the lanes, wherein the surroundings features represent geographical objects, which can be detected by means of a surroundings sensor system of a vehicle. The method furthermore comprises a step of determining areas that make automated driving possible depending on the configuration of the lanes and depending on the surroundings features, a step of creating the digital map by supplementing the base map with the previously determined areas, and a step of providing the digital map for operating the automated vehicle.

A digital map is understood to mean a map that is present in the form of (map) data values on a storage medium. For example, the map is designed to comprise one or more map layers, wherein one map layer, for example, shows a map from the bird's eye view (course and position of roads, buildings, landscape features, etc.). This corresponds to a map of a navigation system, for example. A further map layer comprises, for example, a radar map, wherein surroundings features comprised by the radar map are stored along with a radar signature. A further map layer comprises, for example, a lidar map, wherein surroundings features comprised by the lidar map are stored along with a lidar signature.

In one example embodiment of the present invention, the map is designed as a highly accurate map. The highly accurate map is in particular designed in such a way that it is suitable for the navigation of an automated vehicle. This is understood, for example, to mean that the highly accurate map is designed to determine a highly accurate position of the automated vehicle by comparing stored surroundings features with detected sensor data values of this automated vehicle. For this purpose, the highly accurate map, for example, comprises said surroundings features along with highly accurate position specifications (coordinates).

A highly accurate position is understood to mean a position which is accurate within a specified coordinate system, e.g., WGS84 coordinates, in such a way that this position does not exceed a maximum permitted uncertainty. The maximum uncertainty may depend on the surroundings, for example. Furthermore, the maximum uncertainty can depend, for example, on whether a vehicle is operated manually or in a partially, highly or fully automated manner (corresponding to one of SAE levels 1 to 5). In principle, the maximum uncertainty is so low that safe operation of the automated vehicle is in particular ensured. For a fully automated operation of the automated vehicle, the maximum uncertainty is, for example, in an order of magnitude of about 10 centimeters.

Creating the digital map is understood to mean, for example, that surroundings features, which are comprised by the surroundings data values, are newly integrated into a base map according to their position and/or corresponding surroundings features already comprised by the base map are removed or adjusted. Here, a base map is understood to mean in particular a digital map (as described above).

Retrieving map data values is understood to mean, for example, that an existing base map is (down) loaded in the form of data values from a storage medium or is loaded into a buffer or working memory for processing (here: creating a digital map).

A surroundings sensor system is understood to mean at least one video sensor and/or at least one radar sensor and/or at least one lidar sensor and/or at least one ultrasonic sensor and/or at least one further sensor that is designed to sense the surroundings of a vehicle in the form of surroundings data values. In one possible embodiment of the present invention, the surroundings sensor system comprises, for example, a computing unit (processor, working memory, hard drive) with suitable software and/or is connected to such a computing unit for this purpose.

A surroundings feature is, for example, understood here to mean an infrastructure feature (roadway boundary lines, guardrails, etc.) and/or a traffic sign (road signs, traffic lights, etc.) and/or a structural feature (buildings, bridges, tunnels, etc.) and/or a further feature that can be detected by means of a surroundings sensor system.

A traffic route is, for example, a single-lane or multi-lane road. An area that makes automated driving possible is understood to mean, for example, a portion of the traffic route and a strip to the left and/or right of the traffic route. The width of the strip depends, for example, on the specific configuration of the surroundings and/or the sensor range of the individual vehicles. As a rule, this strip comprises surroundings features such as traffic signs, etc.

A vehicle is, for example, understood to mean a manually operated vehicle (SAE level 0) or an automated vehicle in accordance with one of SAE levels 1 to 5 (see SAE J3016 standard).

(Automated) operation of the (automated) vehicle is understood to mean, for example, the execution of lateral and/or longitudinal control (depending on the SAE level or the configuration of the [automated] vehicle). In one possible embodiment, the operation also comprises, for example, the execution of safety-relevant functions (“arming” an airbag, fastening seat belts, etc.) and/or further (driving assistance) functions.

Providing the digital map is understood to mean that the digital map can be requested and/or received by a vehicle, in particular an automated vehicle.

The method according to the present invention disclosed here advantageously achieves the task of providing a method for creating a digital map, wherein this map is designed in particular to make operating an automated vehicle possible. This object is achieved by means of the method according to the present invention in that areas are determined that allow for automated driving depending on the configuration of the lanes and depending on the surroundings features. This has the advantage that a lane-accurate localization of a vehicle is possible (even when changing lanes) without the constant need for absolute localization of the vehicle within this area, since the vehicle can orient itself along the lanes. This allows an automated vehicle to operate even if the surroundings within this area can only be detected to a limited extent by a surroundings sensor system of the vehicle. These areas are thus in particular characterized in that the existing surroundings sensor system can reliably detect the lanes and thus, for example, also clearly determine which lane the vehicle is actually in, if there are a plurality of lanes for the same driving direction. Furthermore, these areas can be characterized in that a minimum set of surroundings features can be reliably detected within these areas so that safe, in particular automated, operation of a vehicle is possible.

Preferably, the information on the traffic routes includes a width of the relevant lane and/or a total width of the traffic route and/or a configuration, in particular properties of road markings, of the relevant lane.

Properties of road markings are understood to mean, for example, whether the road markings are designed as a solid or dashed line or in another form.

Preferably, the method additionally comprises a step of retrieving sensor information, wherein the sensor information represents at least detection areas of different sensor types, and the areas are determined depending on the detection areas in relation to the spatial arrangement of the lanes.

This is understood to mean that, depending on the sensor type (video, radar, etc.), different areas (here: detection areas) can be detected and that different areas, in the sense of the present invention, can thus also be determined, for example depending on the configuration of the sensor types used in a vehicle. For example, depending on the sensor type, certain areas can be detected with different degrees of detail or at different distances from the vehicle with different degrees of accuracy or reliability.

According to an example embodiment of the present invention, a device, in particular a computing unit, is configured to perform all steps of the method for creating a digital map according to the present invention. A computing unit means, for example, a server or a server network or a cloud.

The device or computing unit comprises a processor, working memory, storage medium, and suitable software in order to perform the method according an embodiment of the present invention. Furthermore, the device comprises an interface in order to transmit and receive data values by means of a wired and/or wireless connection, for example with corresponding devices of vehicles (control units, communication devices, surroundings sensor system, navigation system, etc.) and/or further off-board devices (server, cloud, etc.).

Furthermore, according to an example embodiment of the present invention, a computer program is provided, comprising commands that, when the computer program is executed by a computer, cause the computer to perform a method according to an embodiment of the method of the present invention for creating a digital map. In one embodiment, the computer program corresponds to the software comprised by the second device.

Furthermore, according to an example embodiment of the present invention, a machine-readable storage medium on which the computer program is stored is provided.

The method according to an example embodiment of the present invention for operating an automated vehicle comprises a step of determining a current position of the automated vehicle by means of a satellite-based positioning method, a step of determining a driving strategy for the automated vehicle, depending on the current position, on the basis of a digital map which was created according to one of the example embodiments of the method for creating a digital map (see above), wherein the driving strategy comprises a trajectory to an area that makes automated driving possible, and a step of operating the automated vehicle, depending on the driving strategy.

A current position is understood to mean a position within a specified coordinate system, for example WGS84 coordinates, which can be determined by means of a suitable positioning system (for example, a navigation system for vehicles, and/or a smartphone connected to the vehicle).

Operating an automated vehicle, in particular depending on the driving strategy, is understood to mean, for example, executing a lateral and/or longitudinal control of the automated vehicle, wherein the lateral and/or longitudinal control takes place in such a way that the automated vehicle moves along a trajectory. In one possible embodiment, the operation also comprises, for example, the execution of safety-relevant functions (“arming” an airbag, fastening seat belts, etc.) and/or further (driving assistance) functions.

A trajectory is understood to mean, for example, in relation to a map, a line that the automated vehicle follows. In one embodiment, this line relates, for example, to a fixed point on the automated vehicle. In a further possible embodiment, a trajectory is understood to mean, for example, a travel route envelope through which the automated vehicle drives.

Advantageous developments of the present invention are disclosed herein.

### BRIEF DESCRIPTION OF THE DRAWINGS

Exemplary embodiments of the present invention are illustrated in the figures and explained in more detail in the following description.

FIG. 1 shows an exemplary embodiment of the method according to the present invention for creating a digital map in the form of a flow chart.

FIG. 2 shows an exemplary embodiment of the method according to the present invention for operating an automated vehicle in the form of a flow chart.

### DETAILED DESCRIPTION OF EXAMPLE EMBODIMENTS

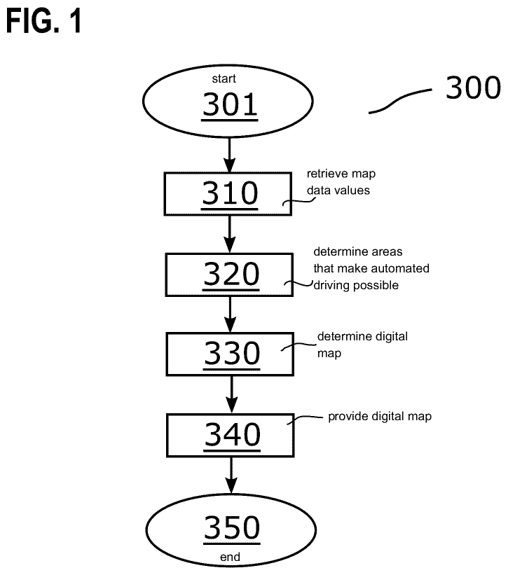

FIG. 1 shows an exemplary embodiment of a method 300 for creating 320 a digital map, which represents at least one area along a traffic route.

In step 301, the method 300 starts.

In step 310, map data values representing a base map are retrieved, wherein the base map comprises information on traffic routes with one or more lanes and surroundings features, wherein this information represents at least one configuration of the lanes, wherein the surroundings features represent geographical objects, which can be detected by means of a surroundings sensor system of a vehicle.

In step 320, areas that make automated driving possible depending on the configuration of the lanes and depending on the surroundings features are determined.

In step 330, the digital map is determined by supplementing the base map with the previously determined areas.

In step 340, the digital map for operating the automated vehicle is provided.

In step 350, the method 300 ends.

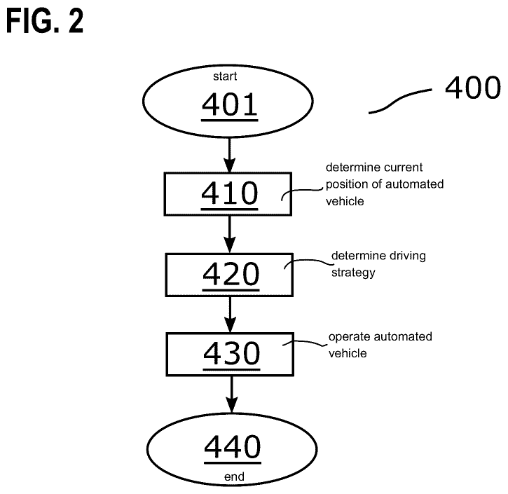

FIG. 2 shows an exemplary embodiment of a method 400 for operating 430 an automated vehicle.

In step 401, the method 400 starts.

In step 410, a current position of the automated vehicle is determined by means of a satellite-based positioning method.

In step 420, a driving strategy for the automated vehicle is determined depending on the current position on the basis of a digital map which was created according to a method 300 for creating 330 a digital map, wherein the driving strategy comprises a trajectory to an area that makes automated driving possible.

In step 430, the automated vehicle is operated depending on the driving strategy.

In step 440, the method 400 ends.

What is claimed is:

1. A method for creating a digital map, comprising the following steps:
retrieving map data values representing a base map, wherein the base map includes information on traffic routes with one or more lanes and surroundings features, wherein the information represents at least one configuration of the lanes, wherein the surroundings features represent geographical objects which can be detected by a surroundings sensor system of a vehicle;
determining areas that make automated driving possible depending on the configuration of the lanes and depending on the surroundings features;
creating the digital map by supplementing the base map with the determined areas; and
providing the digital map for operating an automated vehicle.

2. The method according to claim 1, wherein the information on the traffic routes includes a width of a relevant lane and/or a total width of a traffic route and/or properties of road markings of the relevant lane.

3. The method according to claim 1, further comprising:
retrieving sensor information, wherein the sensor information represents at least detection areas of different sensor types, and the areas are determined depending on the detection areas in relation to a spatial arrangement of the lanes.

4. A device, comprising:
a computing unit for creating a digital map, comprising the following steps:
retrieving map data values representing a base map, wherein the base map includes information on traffic routes with one or more lanes and surroundings features, wherein the information represents at least one configuration of the lanes, wherein the surroundings features represent geographical objects which can be detected by a surroundings sensor system of a vehicle,
determining areas that make automated driving possible depending on the configuration of the lanes and depending on the surroundings features,
creating the digital map by supplementing the base map with the determined areas, and
providing the digital map for operating an automated vehicle.

5. A non-transitory machine-readable storage medium on which is stored a computer program for creating a digital map, the computer program, when executed by a computer, causing the computer to perform the following steps:
retrieving map data values representing a base map, wherein the base map includes information on traffic routes with one or more lanes and surroundings features, wherein the information represents at least one configuration of the lanes, wherein the surroundings features represent geographical objects which can be detected by a surroundings sensor system of a vehicle;
determining areas that make automated driving possible depending on the configuration of the lanes and depending on the surroundings features;
creating the digital map by supplementing the base map with the determined areas; and
providing the digital map for operating an automated vehicle.

6. A method for operating an automated vehicle, comprising the following steps:
determining a current position of the automated vehicle using a satellite-based positioning method;
determining a driving strategy for the automated vehicle, depending on the current position, based on a digital map, the digital map being created by:
retrieving map data values representing a base map, wherein the base map includes information on traffic routes with one or more lanes and surroundings features, wherein the information represents at least one configuration of the lanes, wherein the surroundings features represent geographical objects which can be detected by a surroundings sensor system of a vehicle,
determining areas that make automated driving possible depending on the configuration of the lanes and depending on the surroundings features,
creating the digital map by supplementing the base map with the determined areas,
wherein the driving strategy includes a trajectory to an area that makes automated driving possible; and
operating the automated vehicle, depending on the driving strategy.
